(19) United States
(12) Patent Application Publication
(10) Pub. No.: US 2025/0227635 A1
(43) Pub. Date: Jul. 10, 2025

(54) PHASE OFFSET COMPENSATION DEVICE AND METHOD

(71) Applicant: Samsung Electronics Co., Ltd., Suwon-si (KR)

(72) Inventors: Daehoon KIM, Suwon-si (KR); Jongho OH, Suwon-si (KR); Jinsoo WANG, Suwon-si (KR)

(21) Appl. No.: 19/094,126

(22) Filed: Mar. 28, 2025

Related U.S. Application Data
(63) Continuation of application No. PCT/KR2023/013699, filed on Sep. 13, 2023.

(30) Foreign Application Priority Data
Sep. 28, 2022 (KR) 10-2022-0123336
Oct. 5, 2022 (KR) 10-2022-0126882
Jun. 20, 2023 (KR) 10-2023-0078827
Jun. 23, 2023 (KR) 10-2023-0080789

(51) Int. Cl. H04W 56/00

(52) U.S. Cl. CPC H04W 56/001

(57) ABSTRACT

A phase offset compensation device and a phase offset compensation method performed by a radio unit (RU) of an open radio access network (ORAN) are provided. The method includes receiving, from a distributed unit (DU), information associated with a filter for a channel, wherein the channel uses a section type 3 message of the ORAN, and performing, by the RU, phase offset compensation on the channel after receiving the information.

### CROSS-REFERENCE TO RELATED APPLICATION(S)

This application is a continuation application, claiming priority under 35 U.S.C. § 365 (c), of an International application No. PCT/KR2023/013699, filed on Sep. 13, 2023, which is based on and claims the benefit of a Korean patent application number 10-2022-0123336, filed on Sep. 28, 2022, in the Korean Intellectual Property Office, and of a Korean patent application number 10-2022-0126882, filed on Oct. 5, 2022, in the Korean Intellectual Property Office, and of a Korean patent application number 10-2023-0078827, filed on Jun. 20, 2023, in the Korean Intellectual Property Office, and of a Korean patent application number 10-2023-0080789, filed on Jun. 23, 2023, in the Korean Intellectual Property Office, the disclosure of each of which is incorporated by reference herein in its entirety.

### BACKGROUND

### 1. Field

The disclosure relates to technology for compensating for a phase offset in an open radio access network (ORAN).

### 2. Description of Related Art

An open radio access network (ORAN) is an organization that defines and addresses the fronthaul interface standards between a distributed unit (DU) and a radio unit (RU) according to various function separation structures and provides standard interfaces in a 7-2× function separation structure to which Ethernet is applied.

An ORAN DU (O-DU) and an ORAN RU (O-RU) transmit and receive control information and IQ sample data using a control (C)-plane and a user (U)-plane.

The C-plane includes a transport layer and an application layer, and the application layer includes a section. Section types within the C-plane are determined based on the characteristics of the U-plane being transmitted or received. Among the section types, section type 3 may be used for a channel requiring a time or a frequency offset or for a different-than-nominal sub carrier spacing (SCS) channel.

There are various channels to which section type 3 may be applied, but a channel using section type 3 commonly experiences two types of phase offsets. One is a phase offset according to an upconversion technique, and the other is a phase offset occurring during frequency shift signal processing.

A channel subject to section type 3 includes physical random access channel (PRACH), mixed-numerology, msgA-physical uplink shared channel (PUSCH), and the like, and compensation for both or some of the two types of phase offsets may be required depending on the channel. It is not necessary for an RU to compensate for the two types of phase offsets. Depending on a method of detecting a channel, phase offset compensation may not be required, and even when phase offset compensation is necessary, there is no obligation for the RU to perform compensation. However, when the RU is required to compensate for a phase offset, the RU requires information indicating that compensation is needed. However, under the existing ORAN specifications, the O-RU has no means of knowing what type of phase offset occurs in a signal being processed or whether phase offset compensation is required. In other words, information regarding phase offset does not exist in the ORAN specifications.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and method of compensating for a phase offset in an open radio access network (ORAN).

Additional aspects will be set forth in part in the description which follows and, in part, will be apparent from the description, or may be learned by practice of the presented embodiments.

In accordance with an aspect of the disclosure, a phase offset compensation method performed by a radio unit (RU) of an open radio access network (ORAN) is provided. The method includes receiving, from a distributed unit (DU), information associated with a filter for a channel, wherein the channel uses a section type 3 message of the ORAN, and performing, by the RU, phase offset compensation on the channel after receiving the information.

In accordance with another aspect of the disclosure, a method of operating a distributed unit (DU) in an open radio access network (ORAN) is provided. The method includes generating, by the DU, a section type 3 message including information associated with a filter for a channel, wherein the channel uses the section type 3 message, and transmitting, by the DU, the generated section type 3 message to a radio unit (RU) that performs phase offset compensation on the channel.

In accordance with another aspect of the disclosure, a device is provided. The device includes memory, including one or more storage media, storing one or more instructions, and a processor, communicatively coupled to the memory, executing the one or more instructions, wherein the one or more instructions, when executed by the processor, cause the device to generate a section type 3 message including information associated with a filter for a channel, wherein the channel uses the section type 3 message, and transmit the generated section type 3 message to a radio unit (RU) that performs phase offset compensation on the channel.

In accordance with another aspect of the disclosure, a device is provided. The device includes memory, including one or more storage media, storing one or more instructions, and a processor, communicatively coupled to the memory, executing the one or more instructions, wherein the one or more instructions, when executed by the processor, cause the device to receive, from a distributed unit (DU) of an open radio access network (ORAN), information associated with a filter for a channel, wherein the channel uses a section type 3 message of the ORAN, and perform phase offset compensation on the channel after receiving the information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart illustrating an operation of providing information on whether phase offset compensation is required in a distributed unit (DU) of an open radio access network (ORAN) according to an embodiment of the disclosure;

FIGS. 2A and 2B are diagrams illustrating displaying information related to phase offset compensation through a reserved region of a section extension field of a control (C)-plane message and an example of displaying channel filter information utilizing numPrbc through a reserved region included in filterIndex IE of section type 3 of the C-plane message according to various embodiments of the disclosure;

FIGS. 3A and 3B are diagrams illustrating displaying information related to phase offset compensation through a reserved region within a section type 3 field of a C-plane message and an example of displaying channel filter information utilizing numPrbc through a reserved region included in filterIndex IE of section type 3 of the C-plane message according to various embodiments of the disclosure;

FIG. 4 is a diagram illustrating a format of filterIndex IE of section type 3 of a C-plane message according to an embodiment of the disclosure;

FIG. 5A is a diagram illustrating displaying information related to phase offset compensation through a reserved region included in filterIndex IE of section type 3 of a C-plane message according to an embodiment of the disclosure;

FIGS. 5B and 5C are diagrams illustrating displaying channel information, which is not included in the existing filterIndex IE but may utilize section type 3, through a reserved region included in filterIndex IE of section type 3 in a C-plane message according to various embodiments of the disclosure;

FIG. 6 is a diagram illustrating a DU in an ORAN providing information on whether phase offset compensation is required according to an embodiment of the disclosure; and

FIG. 7 is a diagram illustrating a DU in an ORAN providing information on whether phase offset compensation is required according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, in the description of the components, terms, such as first, second, A, B, (a), (b) or the like may be used herein when describing components of the embodiments. Each of these terms is not used to define an essence, order, or sequence of corresponding components, but used merely to distinguish the corresponding components from other components. It is to be understood that if a component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless stated otherwise, the description of an embodiment may be applicable to other embodiments of the disclosure, and a repeated description related thereto is omitted.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

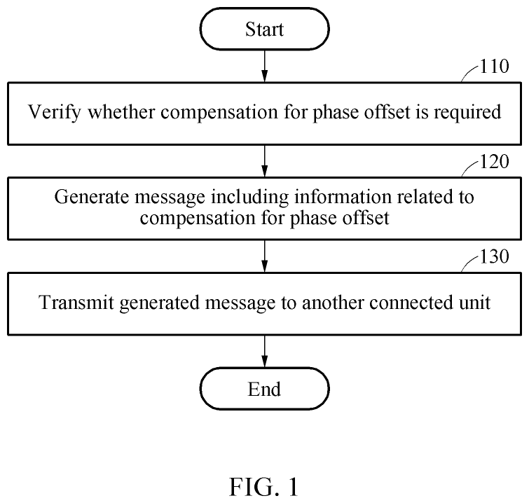

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like. Hereinafter, a device and method of compensating for a phase offset in an open radio access network (ORAN) according to an embodiment are described with reference to FIGS. 1, 2A, 2B, 3A, 3B, 4, 5A, 5B, 5C, 6, and 7.

FIG. 1 is a flowchart illustrating an operation of providing information on whether phase offset compensation is required in a distributed unit (DU) of an ORAN according to an embodiment of the disclosure.

Referring to FIG. 1, the DU of the ORAN may verify whether phase offset compensation is required. In this case, the DU may also be a digital unit (DU).

In operation 110, the DU may verify whether compensation for an offset is required in a channel of section type 3.

In operation 110, the DU may verify whether compensation for a phase offset according to an upconversion technique is required and whether compensation for an offset occurring during frequency shift signal processing is required.

The DU according to an embodiment may generate a message including information related to compensation for a phase offset based on the verification in operation 110. In this case, the information related to the compensation for a phase offset may be information indicating whether the compensation for a phase offset is required.

In operation 120, when the compensation for a phase offset according to the upconversion technique is required, the DU may indicate in the message, using a single bit 212 or 312, whether the compensation for a phase offset according to the upconversion technique is required.

In operation 120, when compensation for an offset occurring during frequency shift signal processing is required, the DU may indicate in the message, using a single bit 214 or 314 whether the compensation for the offset occurring during frequency shift signal processing is required.

More particularly, in operation 120, the DU may generate a message by allocating information related to compensation for a phase offset to a reserved region 210 of a section extension field 200 of a control (C)-plane message.

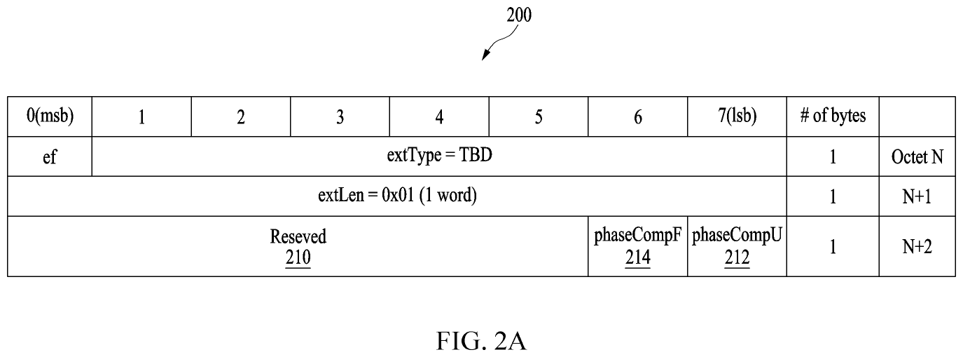

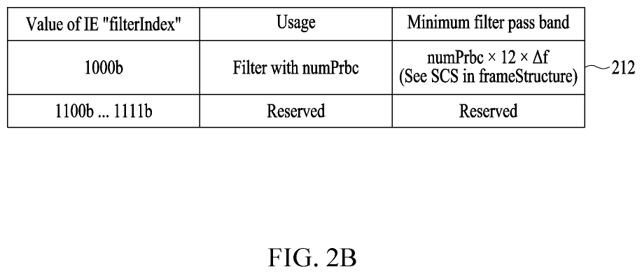

FIGS. 2A and 2B are diagrams illustrating displaying information related to phase offset compensation through a reserved region of a section extension field of a C-plane message and an example of displaying channel filter information utilizing numPrbc through a reserved region included in filterIndex IE of section type 3 of the C-plane message according to various embodiments of the disclosure.

Referring to FIGS. 2A and 2B, a DU may represent, using a single bit, information (phaseCompU 212) indicating whether compensation for a phase offset according to an upconversion technique is required in the reserved region 210 of the section extension field 200 of the C-plane message and may represent, using a single bit, information (phaseCompF 214) indicating whether compensation for an offset occurring during frequency shift signal processing is required.

phaseCompU 212 may have a value of “1” or “0”, and for example, a case in which the value of phaseCompU 212 is “1” may be information indicating that the compensation for a phase offset according to the upconversion technique is required, while a case in which the value of phaseCompU 212 is “0” may be information indicating that the compensation for a phase offset according to the upconversion technique is not required.

phaseCompF 214 may have a value of “1” or “0”, and for example, a case in which the value of phaseCompF 214 is “1” may be information indicating that the compensation for a phase offset occurring during frequency shift signal processing is required, while a case in which the value of phaseCompF 214 is “0” may be information indicating that the compensation for a phase offset occurring during frequency shift signal processing is not required.

phaseCompU 212 is allocated to the 7th bit among the 0th to 7th bits in the reserved region 210, but embodiments are not limited thereto, and phaseCompU 212 may be allocated to any one of the 0th to 7th bits in the reserved region 210.

phaseCompF 214 is allocated to the 6th bit among the 0th to 7th bits in the reserved region 210, but embodiments are not limited thereto, and phaseCompF 214 may be allocated to any one of the 0th to 7th bits in the reserved region 210.

However, phaseCompU 212 and phaseCompF 214 are not allocated to the same bit among the 0th to 7th bits allocated in the reserved region 210.

The DU may display filter passband information based on numPrbc by adding a filter utilizing numPrbc to a reserved region 410 included in filterIndex IE 400 of section type 3 of a C-plane message.

For example, the filter information 212 utilizing numPrbc is allocated to a filter index value of 1000b among the values from 1000b to 1111b allocated in the reserved region 410, but embodiments are not limited thereto, and the filter information 212 may be allocated to any value from 1000b to 1111b in the reserved region 410.

Returning to the description of FIG. 1, in operation 120, the DU may generate the message by allocating the information related to the compensation for a phase offset to a reserved region 310 within a section type 3 field 300 of the C-plane message.

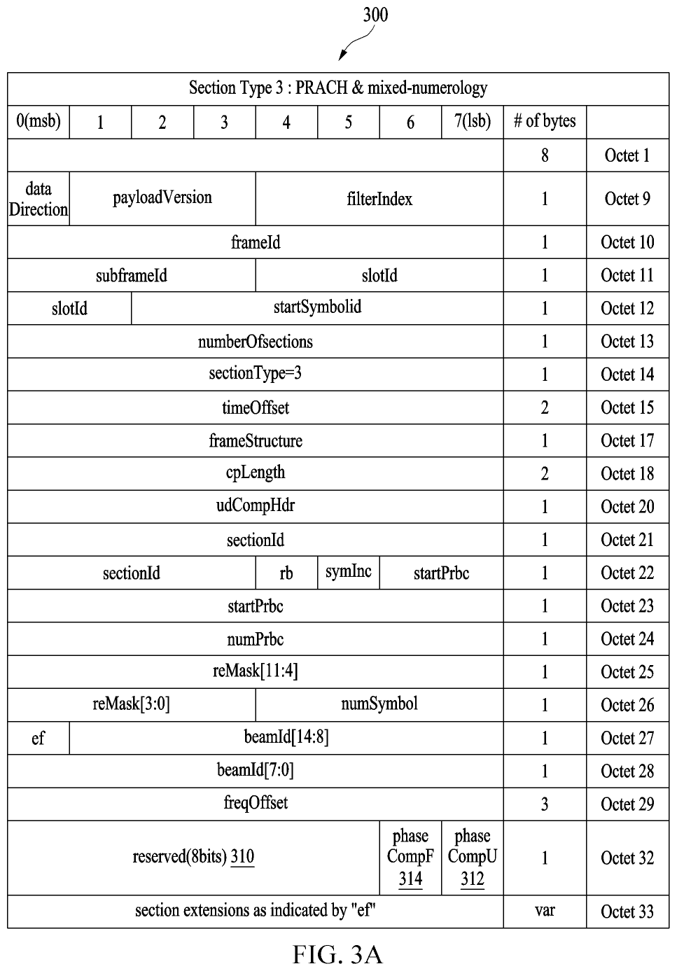

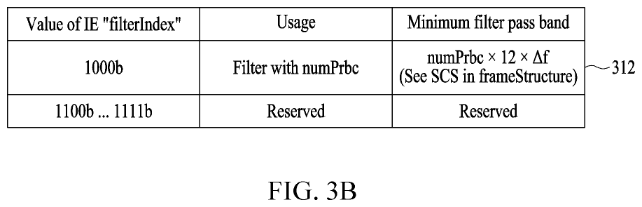

FIGS. 3A and 3B are diagrams illustrating displaying information related to phase offset compensation through a reserved region within a section type 3 field of a C-plane message and an example of displaying channel filter information utilizing numPrbc through a reserved region included in filterIndex IE of section type 3 of the C-plane message, according to various embodiments of the disclosure.

Referring to FIGS. 3A and 3B, a DU may represent, using a single bit, information (phaseCompU 312) indicating whether compensation for a phase offset according to an upconversion technique is required in the reserved region 310 within the section type 3 field 300 of the C-plane message and represent, using a single bit, information (phaseCompF 314) indicating whether compensation for an offset occurring during frequency shift signal processing is required.

phaseCompU 312 may have a value of “1” or “0”, and for example, a case in which the value of phaseCompU 312 is “1” may be information indicating that the compensation for a phase offset according to the upconversion technique is required, and a case in which the value of phaseCompU 312 is “0” may be information indicating that the compensation for a phase offset according to the upconversion technique is not required.

phaseCompF 314 may have a value of “1” or “0”, and for example, a case in which the value of phaseCompF 314 is “1” may be information indicating that the compensation for a phase offset occurring during frequency shift signal processing is required, and a case in which the value of phaseCompF 314 is “0” may be information indicating that the compensation for a phase offset occurring during frequency shift signal processing is not required.

phaseCompU 312 is allocated to the 7th bit among the 0th to 7th bits in the reserved region 310, but embodiments are not limited thereto, and phaseCompU 312 may be allocated to any one of the 0th to 7th bits in the reserved region 310.

phaseCompF 314 is allocated to the 6th bit of the bits among the 0th to 7th bits in the reserved region 310, but embodiments are not limited thereto, and phaseCompF may be allocated to any one of the 0th to 7th bits in the reserved region 310.

However, phaseCompU 312 and phaseCompF 314 are not allocated to the same bit among the 0th to 7th bits allocated in the reserved region 310.

The DU may display filter passband information based on numPrbc by adding a filter utilizing numPrbc to the reserved region 410 included in filterIndex IE 400 of section type 3 of the C-plane message.

For example, the filter information 312 utilizing numPrbc is allocated to a filter index value of 1000b among the values from 1000b to 1111b allocated in the reserved region 410, but embodiments are not limited thereto, and the filter information 312 may be allocated to any value from 1000b to 1111b in the reserved region 410.

Returning to the description of FIG. 1, in operation 120, the DU may generate the message by allocating the information related to the compensation for a phase offset to the reserved region 410 included in filterIndex IE 400 of section type 3 in the C-plane message.

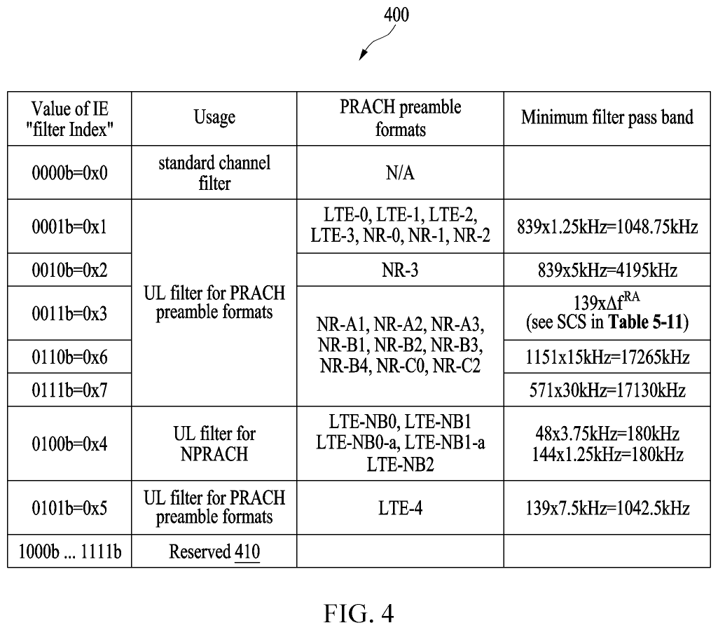

FIG. 4 is a diagram illustrating a format of filterIndex IE of section type 3 of a C-plane message according to an embodiment of the disclosure.

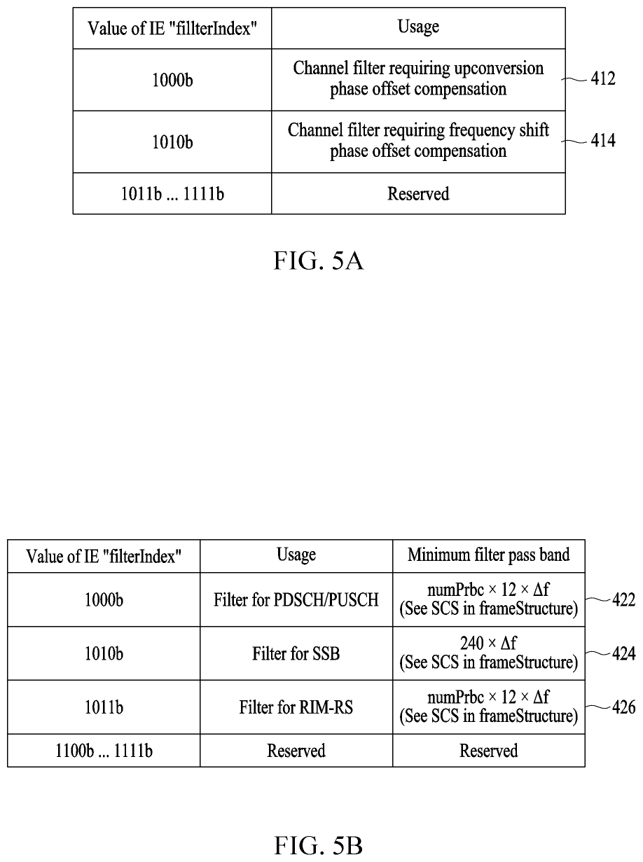

FIG. 5A is a diagram illustrating displaying information related to phase offset compensation through a reserved region included in filterIndex IE of section type 3 of a C-plane message according to an embodiment of the disclosure.

FIGS. 5B and 5C are diagrams illustrating displaying channel information, which is not included in the existing filterIndex IE but may utilize section type 3, through a reserved region included in filterIndex IE of section type 3 in a C-plane message according to various embodiments of the disclosure.

Referring to FIGS. 4 and 5A, a DU may represent, as a preset filter index value, information 412 indicating whether compensation for a phase offset according to the upconversion technique is required in the reserved region 410 included in filterIndex IE 400 of section type 3 in the C-plane message and represent, as a preset filter index value, information 414 indicating whether compensation for an offset occurring during frequency shift signal processing is required.

For example, the information 412 indicating whether the compensation for a phase offset according to the upconversion technique is required is allocated to a filter index value of 1000b among the values from 1000b to 1111b allocated in the reserved region 410, but embodiments are not limited thereto, and the information 412 may be allocated to any value from 1000b to 1111b in the reserved region 410.

In addition, the information 414 indicating whether the compensation for an offset occurring during frequency shift signal processing is required is allocated to a filter index value of 1010b among the values from 1000b to 1111b allocated in the reserved region 410, but embodiments are not limited thereto, and the information 414 may be allocated to any value from 1000b to 1111b in the reserved region 410.

However, the information 412 and the information 414 are not allocated to the same value among the values from 1000b to 1111b allocated in the reserved region 410.

Referring to FIGS. 4 and 5B, the DU may add channels that are not included in the existing filter index element but may utilize section type 3 to the reserved region 410 included in filterIndex IE 400 of section type 3 in the C-plane message.

For example, filter information 422 for physical downlink shared channel (PDSCH)/physical uplink shared channel (PUSCH) is allocated to a filter index value of 1000b among the values from 1000b to 1111b allocated in the reserved region 410, but embodiments are not limited thereto, and the filter information 422 may be allocated to any value from 1000b to 1111b in the reserved region 410.

In addition, filter information 424 for a synchronization signal block (SSB) channel is allocated to a filter index value of 1010b among the values from 1000b to 1111b allocated in the reserved region 410, but embodiments are not limited thereto, and the filter information 424 may be allocated to any value from 1000b to 1111b in the reserved region 410.

In addition, filter information 426 for a remote interference management reference signal (RIM-RS) channel is allocated to a filter index value of 1011b among the values from 1000b to 1111b allocated in the reserved region 410, but embodiments are not limited thereto, and the filter information 426 may be allocated to any value from 1000b to 1111b in the reserved region 410.

In addition, filter information for other channels that may utilize section type 3 may be allocated to any value from 1000b to 1111b allocated in the reserved region 410.

However, the information 422, the information 424, and the information 426 are not allocated to the same value among the values from 1000b to 1111b allocated in the reserved region 410.

Referring to FIGS. 4 and 5C, the DU may add channels that are not included in the existing filter index element but may utilize section type 3 to the reserved region 410 included in filterIndex IE 400 of section type 3 of the C-plane message.

For example, filter information 432 for the PDSCH/PUSCH channels is allocated to a filter index value of 1000b among the values from 1000b to 1111b allocated in the reserved region 410, but embodiments are not limited thereto, and the filter information 432 may be allocated to any value from 1000b to 1111b in the reserved region 410.

Additionally, filter information 434 for the SSB channel is allocated to a filter index value of 1010b among the values from 1000b to 1111b allocated in the reserved region 410, but embodiments are not limited thereto, and the filter information 434 may be allocated to any value from 1000b to 1111b in the reserved region 410.

Additionally, filter information 436 for a 48RB RIM-RS channel is allocated to a filter index value of 1011b among the values from 1000b to 1111b allocated in the reserved region 410, but embodiments are not limited thereto, and the filter information 436 may be allocated to any value from 1000b to 1111b in the reserved region 410.

Additionally, filter information 438 for a 96RB RIM-RS channel is allocated to a filter index value of 1100b among the values from 1000b to 1111b allocated in the reserved region 410, but embodiments are not limited thereto, and the filter information 438 may be allocated to any value from 1000b to 1111b in the reserved region 410.

Additionally, filter information for other channels that may utilize section type 3 may be allocated to any value from 1000b to 1111b allocated in the reserved region 410.

However, the information 432, the information 434, the information 436, and the information 438 are not allocated to the same value among the values from 1000b to 1111b allocated in the reserved region 410.

Returning to the description of FIG. 1, the DU may transmit the generated message to another unit connected to the DU. In this case, the other unit may be a radio unit (RU) or a massive multiple input multiple output (MIMO) unit (MMU).

The other unit that receives the message including information related to the compensation for a phase offset may perform the compensation for the phase offset by referring to the information related to the compensation for the phase offset.

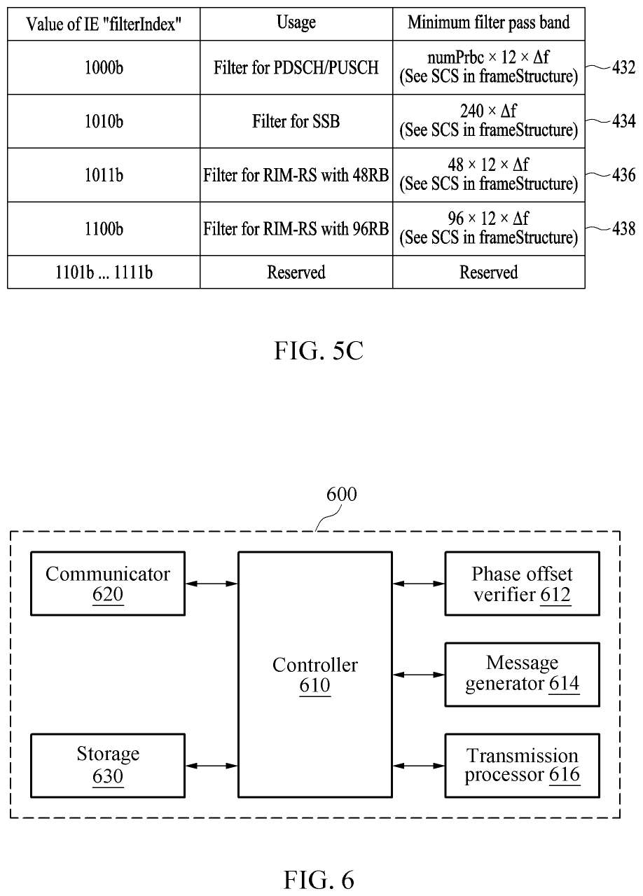

FIG. 6 is a diagram illustrating a DU in an ORAN providing information on whether phase offset compensation is required according to an embodiment of the disclosure.

Referring to FIG. 6, a DU 600 of an ORAN may be configured to include a controller 610, a communicator 620, and a storage 630. The controller 610 may include a phase offset verifier 612, a message generator 614, and a transmission processor 616.

The communicator 620 is a communication interface device that includes a receiver and a transmitter and may communicate with another unit connected to the communicator 620. In this case, the other unit connected to the communicator 620 may be an RU or an MMU.

The storage 630 may store an operating system (OS), an application, and a program for processing the operations of the disclosure to control the overall operation of the DU 600. The storage 630 may be a storage device, such as flash memory, a hard disk drive, or the like.

The phase offset verifier 612 may verify whether compensation for a phase offset is required in an ORAN environment. In this case, the phase offset verifier 612 may verify whether compensation for an offset is required in a channel of section type 3.

The phase offset verifier 612 may verify whether compensation for the phase offset according to an upconversion technique in the channel of section type 3 is required and whether compensation for an offset occurring during frequency shift signal processing is required.

The message generator 614 may generate a message including information related to the compensation for the phase offset, based on the verification performed by the phase offset verifier 612. In this case, the information related to the compensation for the phase offset is information indicating whether the compensation for the phase offset is required.

The message generator 614 may indicate in the message, using a single bit 212 or 312, whether the compensation for the phase offset according to the upconversion technique is required.

The message generator 614 may indicate in the message, using a single bit 214 or 314, whether the compensation for the offset occurring during frequency shift signal processing is required.

The message generator 614 may generate the message by allocating the information related to the compensation for the phase offset to at least one of the reserved region 210 in the section extension field 200 of a C-plane message, the reserved region 310 in the section type 3 field 300 of the C-plane message, and the reserved region 410 included in filterIndex IE 400 of section type 3 of the C-plane message.

The transmission processor 616 may transmit the message generated by the message generator 614 to another unit connected to the DU.

The controller 610 may control the overall operation of the DU 600. Additionally, the controller 610 may perform the functions of the phase offset verifier 612, the message generator 614, and the transmission processor 616. The separation of the controller 610, the phase offset verifier 612, the message generator 614, and the transmission processor 616 in the diagram is for the purpose of distinguishing and describing respective functions. Therefore, the controller 610 may include at least one processor configured to perform the respective functions of the phase offset verifier 612, the message generator 614, and the transmission processor 616. Furthermore, the controller 610 may include at least one processor configured to perform some of the respective functions of the phase offset verifier 612, the message generator 614, and the transmission processor 616.

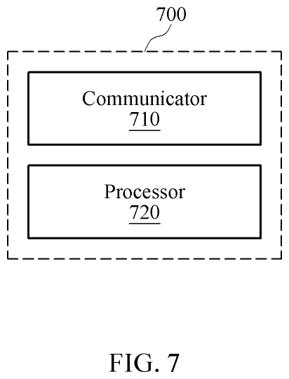

FIG. 7 is a diagram illustrating a DU in an ORAN providing information on whether phase offset compensation is required according to an embodiment of the disclosure.

Referring to FIG. 7, a DU 700 of an ORAN may include a communicator 710 and a processor 720.

The communicator 620 is a communication interface device that includes a receiver and a transmitter and may communicate with another unit connected to the communicator 620. In this case, the other unit connected to the communicator 620 may be an RU or an MMU.

The processor 720 may verify whether compensation for a phase offset is required in an ORAN environment and may generate a message including information related to the compensation for the phase offset and transmit the generated message to another unit connected to the DU based on the verification.

The information related to the compensation for the phase offset, according to an embodiment of the disclosure, may be information indicating whether the compensation for the phase offset is required.

The processor 720, according to an embodiment of the disclosure, may verify whether compensation for the phase offset according to an upconversion technique in a channel of section type 3 is required and whether compensation for an offset occurring during frequency shift signal processing is required.

The processor 720, according to an embodiment of the disclosure, may indicate in the message, using a single bit 212 or 312, whether the compensation for the phase offset according to the upconversion technique is required and indicate in the message, using a single bit 214 or 314, whether the compensation for the offset occurring during frequency shift signal processing is required.

The processor 720 according to an embodiment of the disclosure may generate the message by allocating the information related to the compensation for the phase offset to at least one of the reserved region 210 in the section extension field 200 of the C-plane message, the reserved region 310 in the section type 3 field 300 of the C-plane message, and the reserved region 410 included in filterIndex IE 400 of section type 3 of the C-plane message.

According to an embodiment of the disclosure, a phase offset compensation method in an ORAN may include operation 110 of verifying, in a DU 600 or 700, whether compensation for a phase offset is required, operation 120 of generating a message including information related to the compensation for the phase offset based on the verification in the DU 600 or 700, and operation 130 of transmitting the generated message from the DU 600 or 700 to another unit connected to the DU.

In this case, the information related to the compensation for the phase offset may be information indicating whether the compensation for the phase offset is required.

According to an embodiment of the disclosure, operation 110 of verifying whether the compensation for the phase offset is required may include verifying, in the DU 600 or 700, whether the compensation for the offset is required in a channel of section type 3.

According to an embodiment of the disclosure, operation 110 of verifying whether the compensation for the phase offset is required may include verifying whether the compensation for the phase offset according to an upconversion technique is required and whether the compensation for the offset occurring during frequency shift signal processing is required.

According to an embodiment of the disclosure, operation 120 of generating the message including the information related to the compensation for the phase offset based on the verification may include, when the compensation for the phase offset according to the upconversion technique is required, indicating in the message, using a single bit 212 or 312, whether the compensation for the phase offset is required.

According to an embodiment of the disclosure, operation 120 of generating the message including the information related to the compensation for the phase offset based on the verification may include, when the compensation for the offset occurring during frequency shift signal processing is required, indicating in the message, using a single bit 214 or 314, whether the compensation for the offset occurring during the frequency shift signal processing is required.

According to an embodiment of the disclosure, operation 120 of generating the message including the information related to the compensation for the phase offset based on the verification may include indicating in the message, using a single bit 212 or 312, whether the compensation for the phase offset according to the upconversion technique is required and indicating in the message, using a single bit 214 or 314, whether the compensation for the offset occurring during frequency shift signal processing is required.

According to an embodiment of the disclosure, operation 120 of generating the message including the information related to the compensation for the phase offset based on the verification may include generating the message by allocating the information related to the compensation for the phase offset to the reserved region 210 of the section extension field 200 in the C-plane message.

According to an embodiment of the disclosure, operation 120 of generating the message including the information related to the compensation for the phase offset based on the verification may include generating the message by allocating the information related to the compensation for the phase offset to the reserved region 310 within the section type 3 field 300 of the C-plane message.

According to an embodiment of the disclosure, operation 120 of generating the message including the information related to the compensation for the phase offset based on the verification may include generating the message by allocating the information related to the compensation for the phase offset to the reserved region 410 included in filterIndex IE 400 of section type 3 of the C-plane message.

According to an embodiment of the disclosure, the DU 600 may include the phase offset verifier 612 configured to verify whether compensation for a phase offset is required in an ORAN environment, the message generator 614 configured to generate a message including information related to the compensation for the phase offset based on the verification, and the transmission processor 616 configured to transmit the generated message to another unit connected to the DU.

According to an embodiment of the disclosure, the information related to the compensation for the phase offset may be information indicating whether the compensation for the phase offset is required.

According to an embodiment of the disclosure, the phase offset verifier 612 may verify whether the compensation for the phase offset according to the upconversion technique is required in a channel of section type 3 and whether compensation for an offset occurring during frequency shift signal processing is required.

According to an embodiment of the disclosure, the message generator 614 may indicate in the message, using a single bit 212 or 312, whether the compensation for the phase offset according to the upconversion technique is required and indicate in the message, using a single bit 214 or 314, whether the compensation for the offset occurring during frequency shift signal processing is required.

According to an embodiment of the disclosure, the message generator 614 may generate the message by allocating the information related to the compensation for the phase offset to at least one of the reserved region 210 in the section extension field 200 of the C-plane message, the reserved region 310 in the section type 3 field 300 of the C-plane message, and the reserved region 410 included in filterIndex IE 400 of section type 3 in the C-plane message.

According to an embodiment of the disclosure, a DU in an ORAN that compensates for a phase offset may include the communicator 710 and the processor 720, wherein the processor 720 may verify whether compensation for a phase offset is required in an ORAN environment, generate a message including information related to the compensation for the phase offset based on the verification, and transmit the generated message to another unit connected to the DU.

According to an embodiment of the disclosure, the information related to the compensation for the phase offset may be information indicating whether the compensation for the phase offset is required.

According to an embodiment of the disclosure, the processor 720 may verify whether the compensation for the phase offset according to an upconversion technique in a channel of section type 3 is required and whether compensation for an offset occurring during frequency shift signal processing is required.

According to an embodiment of the disclosure, the processor 720 may indicate in the message, using a single bit 212 or 312, whether the compensation for the phase offset according to the upconversion technique is required and indicate in the message, using a single bit 214 or 314, whether the compensation for the offset occurring during frequency shift signal processing is required.

According to an embodiment of the disclosure, the processor 720 may generate the message by allocating the information related to the compensation for the phase offset to at least one of the reserved region 210 in the section extension field 200 of the C-plane message, the reserved region 310 in the section type 3 field 300 of the C-plane message, and the reserved region 410 included in filterIndex IE 400 of section type 3 of the C-plane message.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments of the disclosure, or they may be of the kind well-known and available to those having skill in the computer software arts. Examples of non-transitory computer-readable media include magnetic media, such as hard disks, floppy disks, and magnetic tape, optical media, such as compact disc read only memory (CD-ROM) discs or digital versatile disc (DVDs), magneto-optical media, such as floptical disks, and hardware devices that are specially configured to store and perform program instructions, such as read only memory (ROM), random-access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the embodiments of the disclosure, or vice versa.

Software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A phase offset compensation method performed by a radio unit (RU) of an open radio access network (ORAN), the method comprising:
receiving, from a distributed unit (DU), information associated with a filter for a channel, wherein the channel uses a section type 3 message of the ORAN; and
performing, by the RU, phase offset compensation on the channel after the receiving of the information.

2. The method of claim 1, wherein the channel includes at least one of physical data shared channel (PDSCH), physical uplink shared channel (PUSCH), or synchronization signal block (SSB) channel.

3. The method of claim 1, wherein the phase offset compensation includes compensation for a phase offset according to an upconversion technique or compensation for a phase offset occurring during frequency shift signal processing.

4. The method of claim 1, wherein the information associated with the filter for the channel is included in a filterIndex field of the section type 3 message.

5. The method of claim 1, wherein the filter is a pass band filter.

6. A method of operating a distributed unit (DU) in an open radio access network (ORAN), the method comprising:
generating, by the DU, a section type 3 message comprising information associated with a filter for a channel, wherein the channel uses the section type 3 message; and
transmitting, by the DU, the generated section type 3 message to a radio unit (RU) that performs phase offset compensation on the channel.

7. The method of claim 6, wherein the channel includes at least one of physical data shared channel (PDSCH), physical uplink shared channel (PUSCH), or synchronization signal block (SSB) channel.

8. The method of claim 6, wherein the phase offset compensation includes compensation for a phase offset according to an upconversion technique or compensation for a phase offset occurring during frequency shift signal processing.

9. The method of claim 6, wherein the information associated with the filter for the channel is included in a filterIndex field of the section type 3 message.

10. The method of claim 6, wherein the filter is a pass band filter.

11. A device comprising:
memory, comprising one or more storage media, storing one or more instructions; and
a processor, communicatively coupled to the memory, executing the one or more instructions,
wherein the one or more instructions, when executed by the processor, cause the device to:
generate a section type 3 message comprising information associated with a filter for a channel, wherein the channel uses the section type 3 message, and
transmit the generated section type 3 message to a radio unit (RU) that performs phase offset compensation on the channel.

12. The device of claim 11, wherein the channel includes at least one of physical data shared channel (PDSCH), physical uplink shared channel (PUSCH), or synchronization signal block (SSB) channel.

13. The device of claim 11, wherein the phase offset compensation includes compensation for a phase offset according to an upconversion technique or compensation for a phase offset occurring during frequency shift signal processing.

14. The device of claim 11, wherein the information associated with the filter for the channel is included in a filterIndex field of the section type 3 message.

15. The device of claim 11, wherein the filter is a pass band filter.

16. A device comprising:
memory, comprising one or more storage media, storing one or more instructions; and
a processor, communicatively coupled to the memory, executing the one or more instructions,
wherein the one or more instructions, when executed by the processor, cause the device to:
receive, from a distributed unit (DU) of an open radio access network (ORAN), information associated with a filter for a channel, wherein the channel uses a section type 3 message of the ORAN; and
perform phase offset compensation on the channel after receiving the information.

17. The device of claim 16, wherein the channel includes at least one of physical data shared channel (PDSCH), physical uplink shared channel (PUSCH), or synchronization signal block (SSB) channel.

18. The device of claim 16, wherein the phase offset compensation includes compensation for a phase offset according to an upconversion technique or compensation for a phase offset occurring during frequency shift signal processing.

19. The device of claim 16, wherein the information associated with the filter for the channel is included in a filterIndex field of the section type 3 message.

20. The device of claim 16, wherein the filter is a pass band filter.
